(19) United States
(12) Patent Application Publication
(10) Pub. No.: US 2005/0231561 A1
(43) Pub. Date: Oct. 20, 2005

(54) Liquid discharge head, liquid cartridge, liquid discharge apparatus, and imaging apparatus

(76) Inventor: Kenichiroh Hashimoto, Kanagawa (JP)

Correspondence Address: COOPER & DUNHAM, LLP, 1185 AVENUE OF THE AMERICAS, NEW YORK, NY, 10036, US

(21) Appl. No.: 11/102,162

(22) Filed: Apr. 8, 2005

(30) Foreign Application Priority Data
Apr. 14, 2004 (JP) 2004-118730

(51) Int. Cl. B41J 2/05

(52) U.S. Cl. 347/56

(57) ABSTRACT

A liquid discharge head is disclosed that includes plural device substrates including at least a first device substrate and a second device substrate, each of at least the first device substrate and the second device substrate including plural discharge outlets for discharging a plurality of types of liquids, and at least one of the types of liquids being used for at least one output image and not being used for at least one other output image, wherein for each output image, the number of types of liquids used in at least the first device substrate and the second device substrate is arranged to be substantially the same.

### BACKGROUND OF THE INVENTION

1. Field of the Invention

The present invention relates to a liquid discharge head, a liquid cartridge, a liquid discharge apparatus, and an imaging apparatus.

2. Description of the Related Art

An ink jet recording apparatus including a liquid discharge apparatus implementing a liquid discharge head as a recording head may be applied to an imaging apparatus such as a printer, a facsimile machine, a copier, or a multi-function imaging apparatus realizing more than one of these functions, for example. An ink jet recording apparatus is configured to discharge ink from an ink jet head onto a sheet of paper, for example, and is capable of recording a high resolution color image with high speed. It is noted that the recording medium is not limited to paper and includes any type of material (e.g., OHP sheet, textile) on which liquid such as ink may be transferred. It is noted that in recent years and continuing, the ink jet recording apparatus is also being applied to industrial systems such as a textile printing apparatus, for example.

In an imaging apparatus using the ink jet recording method as is described above, four colors including three primary colors, yellow (Y), magenta (M), and cyan (C), and black (Bk) are generally used.

However, in response to the increasing demand for outputting photographic images, a technique is being developed involving the use of thin ink (also referred to as light color ink or photo ink) in addition to the four colors, yellow (Y), magenta (M), cyan (C), and black (Bk) as is described above, the thin ink being used to reduce the graininess of a light portion of a recorded image (e.g., see Japanese Patent No. 3428980).

Also, techniques are disclosed in Japanese Laid-Open Patent Publication No. 2000-229424 and Japanese Lai-d-Open Patent Publication No. 2003-276300, for example, involving the use of distinct color inks such as red (R), green (G), and blue (B) in order to improve color reproducibility and reduce the total amount of ink used.

Also, a technique is disclosed in U.S. Pat. No. 4,723,129 pertaining to a thermal head that is used as a liquid discharge type recording head (e.g., ink jet head), the thermal head including a discharge outlet for discharging liquid, a flow path that is connected to the outlet, and an electric heat converter (heating element) provided within the flow path and corresponding to energy generating means that generates energy for discharging the liquid, wherein energy such as heat is applied to the liquid contained within the flow path to induce air bubble formation, and liquid is discharged from the outlet by the force created by the abrupt change in the liquid volume.

The thermal head is capable of recording a high quality image with high speed and low noise, and the ink outlets of the thermal head for discharging ink may be densely arranged so that a high resolution image may be recorded with a small ink head apparatus, and a color image may be easily recorded, for example.

It is noted that other forms of liquid discharge heads include a piezoelectric head that uses a piezoelectric element as energy generating means, and an electrostatic head that drives an oscillation plate using electrostatic power, for example.

In a liquid discharge head that is arranged to discharge 6˜10 different types of inks to obtain good image quality, a large number of ink outlets are required. That is, rows of outlets have to be provided in proportion to the number of different inks being used, and in a case where two rows of ink outlets are provided for each type of ink in a zigzag arrangement to realize high density and high speed recording, 12˜20 rows of outlets are required.

When the number of rows of outlets is increased, the size of the recording head is increased, and in turn, the cost of the recording head is increased. Particularly, the cost of a device substrate implementing the energy generating means for discharging liquid from the outlets makes up a large part of the cost increase. Thus, a technique is known in which plural device substrates are used to counter this problem. A silicon substrate is generally used as the device substrate, and the cost varies depending on how many device substrates may be fabricated on one silicon substrate (silicon wafer).

By dividing the device substrate into plural small device substrates, the circular area of the silicon substrate may be efficiently used to thereby realize cost reduction. It is noted that the yield is also an important factor influencing the cost, and by dividing the device substrate into plural small device substrates, the yield may be improved and further cost reduction may be realized.

However, when a device substrate implementing energy generating means is divided into plural device substrates, a temperature difference may be created between the plural substrates due to the difference in the heat generated at the respective device substrates. It is noted that a device substrate generates heat from driving at least 1000 energy generating elements at several to several dozen kHz. Such a heat generation is particularly prominent in a thermal head that uses a heating element as the energy generating means or a device substrate integrating a driver, for example.

When heat is generated at the divided device substrates, a temperature difference may be created between the device substrates due to a difference in the amount of heat generated at the respective device substrates. Owing to such a temperature difference, a variation in the ink temperature and a variation in the thermal expansion of the device substrates may occur so that a variation in the ink discharging characteristics of the device substrates occurs. As a result, the output image may be degraded.

### SUMMARY OF THE INVENTION

Accordingly, the present invention has been conceived in response to one or more of the problems of the related art and its object is to provide a liquid discharge head, a liquid cartridge, a liquid discharge apparatus, and an imaging apparatus in which the occurrence of a variation in the liquid discharge characteristics of plural device substrates may be prevented.

According to an aspect of the present invention, a liquid discharge head is provided that includes plural device substrates including at least a first device substrate and a second device substrate, each of at least the first device substrate and the second device substrate including plural discharge outlets for discharging plural types of liquids, and at least one of the types of liquids being used for at least one output image and not being used for at least one other output image, wherein for each output image, the number of types of liquids used in at least the first device substrate and the second device substrate is arranged to be the same.

According to another aspect of the present invention, a liquid discharge head is provided that includes plural device substrates including at least a first device substrate and a second device substrate, each of at least the first device substrate and the second device substrate including plural discharge outlets for discharging plural types of liquids, and at least one of the types of liquids being used for at least one output image and not being used for at least one other output image, wherein the number of types of liquids only used for a particular output image in at least the first device substrate and the second device substrate is arranged to be the same.

According to another aspect of the present invention, a liquid discharge head is provided that includes plural device substrates including at least a first device substrate and a second device substrate, each of at least the first device substrate and the second device substrate including plural discharge outlets for discharging at least five types of liquids, and at least one of the types of liquids being used for at least one output image and not being used for at least one other output image, wherein for each output image, the difference in the number of types of liquids used in at least the first device substrate and the second device substrate is arranged to be no more than one.

According to another aspect of the present invention, a liquid discharge head is provided that includes plural device substrates including at least a first device substrate and a second device substrate, each of at least the first device substrate and the second device substrate including plural discharge outlets for discharging at least five types of liquids, and at least one of the types of liquids being used for at least one output image and not being used for at least one other output image, wherein the difference in the number of types of liquids only used for a particular output image in at least the first device substrate and the second device substrate is arranged to be no more than one.

According to another aspect of the present invention, a liquid cartridge is provided that includes a liquid discharge head of the present invention, and a liquid container storing the liquid that is to be supplied to the liquid discharge head.

According to another aspect of the present invention, a liquid discharge apparatus is provided that includes a liquid discharge head of the present invention.

According to another aspect of the present invention, an imaging apparatus is provided that includes a liquid discharge head of the present invention.

### BRIEF DESCRIPTION OF THE DRAWINGS

FIG. 1 is a perspective view of a liquid discharge head according to a first embodiment of the present invention;

FIG. 2 is a diagram showing the surfaces of device substrates of the liquid discharge head of the first embodiment on which surfaces discharge outlets are formed;

FIG. 3 is a diagram showing a portion of the discharge outlets of the liquid discharge head of the first embodiment;

FIG. 4 is a cross-sectional view of the liquid discharge head of FIG. 2 across line X1-X1 along a main scanning direction;

FIG. 5 is a diagram showing surfaces of device substrates of a liquid discharge head according to a second embodiment of the present invention on which surfaces discharge outlets are formed;

FIG. 6 is a diagram showing surfaces of device substrates of a liquid discharge head according to a modified embodiment of the present invention, on which surface discharge outlets are formed;

FIG. 7 is a diagram illustrating an exemplary recording method that is realized using the liquid discharge head of FIG. 6;

FIG. 8 is a diagram illustrating an overlapping of dots in the recording method according to the present example;

FIG. 9 is a diagram showing surfaces of device substrates of a liquid discharge head according to a third embodiment of the present invention on which surfaces discharge outlets are formed;

FIG. 10 is a diagram showing surfaces of device substrates of a liquid discharge head according to a fourth embodiment of the present invention on which surfaces discharge outlets are formed;

FIG. 11 is a diagram showing surfaces of device substrates of a liquid discharge head according to a fifth embodiment of the present invention on which surfaces discharge outlets are formed;

FIG. 12 is a perspective view of a liquid cartridge according to an embodiment of the present invention;

FIG. 13 is a diagram showing an overall structure of an imaging apparatus according to an embodiment of the present invention; and

FIG. 14 is a plan view of the imaging apparatus according to the present embodiment.

### DESCRIPTION OF THE PREFERRED EMBODIMENTS

In the following, preferred embodiments of the present invention are described with reference to the accompanying drawings.

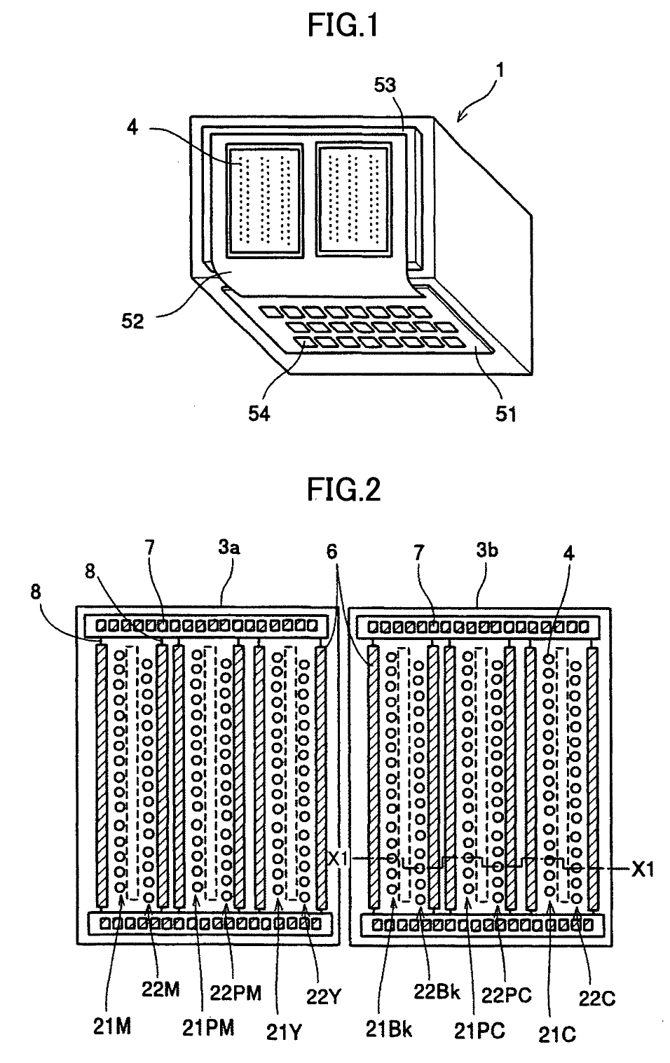

First, a liquid discharge head according to a first embodiment of the present invention is described with reference to FIGS. 1˜4.

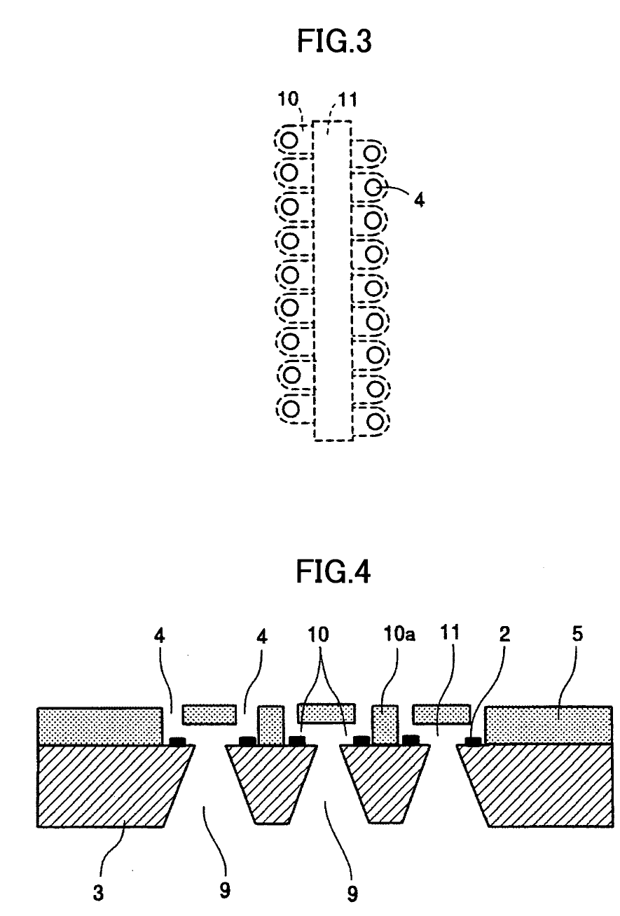

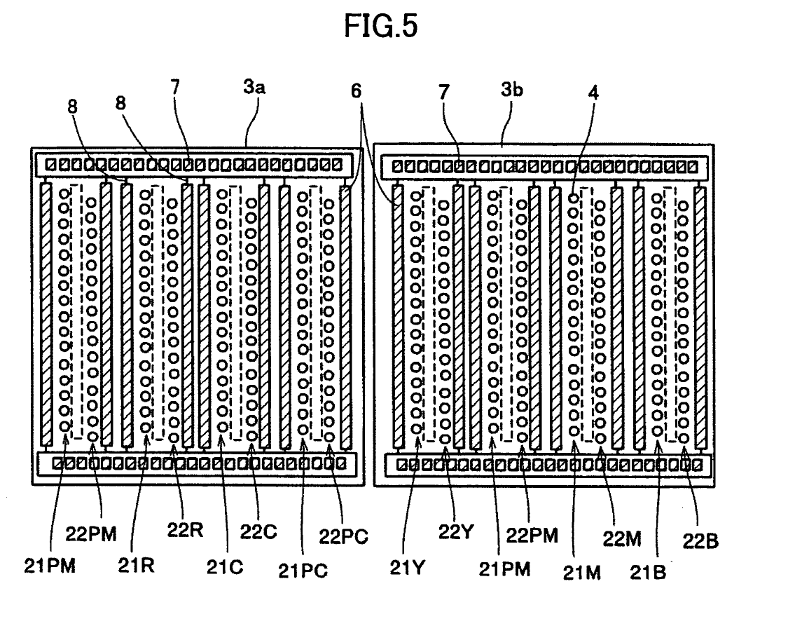

FIG. 1 is a perspective view of the liquid discharge head according to the present embodiment; FIG. 2 is a diagram showing an arrangement of discharge outlets formed on the surface of device substrates of the liquid discharge head of FIG. 1 which arrangement may be observed by removing a flexible wiring board; FIG. 3 is a diagram showing a portion of the outlets of the liquid discharge head of the present embodiment; and FIG. 4 is a cross-sectional view of the discharge head of FIG. 2 across the main scanning direction along line X1-X1.

The liquid discharge head 1 according to the present embodiment includes device substrates 3a and 3b (referred to as device substrate 3 when no distinctions are made between the two device substrates 3a and 3b) implementing heating resistor elements 2 as energy converting elements, and an orifice plate 5 on which discharge outlets 4 are formed.

The device substrate 3 may be formed by a silicon single crystal with a plane direction of (100), for example. At the connection plane between the device substrate 3 and the orifice plate 5, the heating resistor element 2, a drive circuit 6 including a drive transistor for driving the heating resistor element 2, a contact pad 7 for realizing connection with the orifice plate 5 via a wiring board 51 and a flexible wiring board 52, and wiring 8 for realizing connection between the drive circuit 6 and the contact pad 7 are formed through semiconductor processing.

It is noted that the wiring board 51 has terminals 54 formed thereon for realizing electrical connection with an imaging apparatus such as an ink jet recording apparatus (not shown) when the liquid discharge head 1 is set to such an apparatus. Also, three through holes that are formed through anisotropic etching are provided at regions of the device substrate at which the drive circuit 6, the heating resistor element 2, the wiring 8, and the contact head 7 are not formed. The through holes correspond to liquid (ink) supply holes 9 for supplying liquid such as ink to discharge outlet rows 21M, 22M, 21PM, 22PM, 21Y, 22Y, 21Bk, 22Bk, 21PC, 22PC, 21C, and 22C that are arranged to discharge different types of liquid as is described below.

FIG. 3 illustrates a case in which a substantially transparent orifice plate 5 is placed on the device substrate 3. It is noted that the ink supply holes 9 are omitted from this drawing. The device substrate 3 is connected to a base substrate 53 that may be made of ceramic material, for example.

The orifice plate 5 may be made of photoconductive epoxy resin, for example. At the orifice plate 5, the discharge outlets 4, common liquid chambers 11 connected to liquid flow paths 10 and the ink supply holes 9, and partition walls 10a dividing the liquid flow paths 10 are formed according to the positions of the heating resistor elements 2 of the device substrate 3. According to an embodiment, the anisotropic etching for forming the device substrate 3 may be realized by forming a silicon oxide film or a silicon nitride film on a silicon substrate, forming the orifice plate 5 with the through holes 9, discharge outlets 4, and the liquid flow paths 10, and removing the silicon oxide film or the silicon nitride film from the portions corresponding to the ink supply holes 9 to produce the liquid discharge head 1 with high accuracy and low cost.

The liquid discharge head 1 including the device substrates 3a and 3b and the orifice plate 5 as is described above uses the pressure from air bubbles that are generated when the film is boiled by the heat energy from the electric heat converting element (heating resistor element 2) to discharge liquid such as ink (recording liquid) from the discharge outlets 4 to conduct recording.

As is shown in FIG. 2, in the present example, the device substrate 3 of the liquid discharge head 1 is divided into two device substrates 3a and 3b. The device substrate 3a includes discharge outlet rows 21M, 22M, 21PM, 22PM, 21Y, and 22Y that are arranged to discharge inks corresponding to magenta (M), photo magenta (PM), and yellow (Y), respectively. The device substrate 3b includes discharge outlet rows 21Bk, 22Bk, 21PC, 22PC, 21C, and 22C that are arranged to discharge inks corresponding to black (Bk), photo cyan (PC), and cyan (C), respectively.

The device substrates 3a and 3b are aligned in a direction that is perpendicular to the alignment direction of the discharge outlets 4. That is, the device substrates 3a and 3b are aligned along a main scanning direction while the discharge outlets 4 of the outlet rows are aligned along the sub scanning direction. It is noted that in the following descriptions, the discharge outlet rows are simply referred to as discharge outlet row 21 and discharge outlet row 22 in a case where the corresponding colors of the discharge outlet rows are not particularly relevant.

It is also noted that the discharge outlets 4 of the discharge outlet row 21 and the discharge outlets 4 of the discharge outlet row 22 are arranged into a zigzag formation. In the liquid discharge head 1 according to the present embodiment, 384 discharge outlets 4 are provided at a pitch of approximately 42 μm ( 1/600 inch) in each of the outlet rows 21 and 22; that is, 768 discharge outlets 4 arranged into a zigzag formation are assigned to each ink color. In the present embodiment, since two rows of discharge outlets 4 at 600 dpi are formed in a zigzag arrangement, printing at 1200 dpi may be realized in one scan (main scanning direction movement).

Photo ink corresponds to an ink with low concentration that is used to reduce the graininess of a highlighted portion of an image to obtain good image quality, particularly, photographic image quality. Since black (Bk) ink is only used at dark portions of an image, the graininess of a black dot in the image may not be very prominent. Also, since yellow (Y) ink has high brightness, the graininess of a yellow dot in the image may not be very prominent. Accordingly, in the present embodiment, photo inks of yellow (Y) and black (Bk) are not used since such inks may not make a large difference to the overall image quality of a printed image. Thus, in the present embodiment, photo magenta (PM) and photo cyan (PC) are used to improve the image quality of an output image.

By using distinct color inks in addition to the three primary color inks yellow (Y), magenta (M), and cyan (C), image quality may be further improved particularly with respect to outputting photographic images.

As is described above, the device substrate 3 of the liquid discharge head 1 is divided into two device substrates 3a and 3b. Since the device substrates 3a and 3b are fabricated from a silicon substrate (silicon wafer) using semiconductor processing, the cost of the liquid discharge head 1 may vary significantly depending on how many device substrates are formed on one silicon wafer. When the size of a device substrate is relatively large, the area of the silicon wafer may not be efficiently used, and a large portion of the area of the silicon wafer may be wasted. Thus, by dividing the device substrate into plural small device substrates, the area of the silicon wafer may be efficiently used, thereby leading to cost reduction.

Also, it is noted that in the semiconductor processing, defective device substrates are created at a certain probability, and the probability of the occurrence of defects maybe lowered when the size of the device substrate being formed is decreased. Thus, according to the present embodiment, the yield may be improved thereby leading to further cost reduction.

However, when a signal is input to the liquid discharge head 1, the temperature of the device substrate 3 increases due to heat generation at the heating resistor element 2 and the drive circuit 6, for example, and in a case where the device substrate 3 is divided into plural device substrates 3a and 3b as is described above, a temperature difference may be created between the device substrates 3a and 3b owing to the difference in the heat increase of the device substrates 3a and 3b, for example. As a result, a variation may occur in the ink temperature at the device substrates 3a and 3b, a variation may occur in the thermal expansion of the device substrates 3a and 3b, and a variation may be created in the ink discharging characteristics and pitch of the discharge outlets of the device substrates 3a and 3b, for example, so that the printing quality may be degraded.

To counter the problems described above, the device substrates 3a and 3b of the liquid discharge head 1 are arranged to use the same number of inks (ink types) for outputting an image. Specifically, the photo inks (i.e., photo magenta (PM) and photo cyan (PC)) that are only used for outputting a photographic image are equally distributed to the device substrates 3a and 3b.

Table 1 as is shown below indicates the ink colors (ink types) assigned to the discharge outlet rows 21 of the device substrates 3a and 3b of the liquid discharge head 1 of the present embodiment, and the inks (ink types) used in a document output operation and a photograph output operation according to the present embodiment.

TABLE 1

| | Device Substrate 3a | | | Device Substrate 3b | | |
|---|---|---|---|---|---|---|
| Outlet Row Ink Color | M | PM | Y | Bk | PC | C |
| Document Output | ◯ | — | ◯ | ◯ | — | ◯ |
| Photograph Output | ◯ | ◯ | ◯ | ◯ | ◯ | ◯ |

◯: used, —: not used

It is noted that an ink jet recording apparatus of the present embodiment is arranged to conduct a document output operation for outputting a document including text and graphics, for example, and a photograph output operation for outputting a photographic image or a gradation image, for example. When outputting a photographic image or a gradation image, the image quality of the output image may be degraded by the graininess of a highlighted portion of the output image, and thereby, photo inks are used to output a high quality photographic image.

As is shown in Table 1, according to the present embodiment, the same number of ink types is used at the device substrates 3a and 3b for realizing a document output operation, and the same number of ink types is used at the device substrates 3a and 3b for realizing a photograph output operation. Specifically, according to the present embodiment, photo magenta (PM) and photo cyan (PC) that are only used in a photograph output operation are equally distributed to the device substrates 3a and 3b. In other words, the same number of ink types used for only a particular output image is assigned to the device substrates 3a and 3b.

In this way, the temperature difference in the device substrates 3a and 3b caused by a difference in the heat generated from driving the liquid discharge head 1 may be reduced, and a variation in the liquid discharge characteristics of the device substrates 3a and 3b due to the temperature difference may be reduced so that good image quality may be obtained.

As is described above, according to the present embodiment, in each image output operation the same number of ink types is used at plural device substrates, and thereby, the temperature difference between the device substrates that are heated by the heat generated upon driving the liquid discharge head may be reduced, and the variation in the liquid discharge characteristics of the device substrates may be reduced so that good image quality may be obtained.

Also, by equally distributing the ink types only used in a particular image output operation to the plural device substrates, the same number of ink types only used for outputting a particular output image may be assigned to the plural device substrates, and thereby, the temperature difference between the device substrates that are heated by the heat generated upon driving the liquid discharge head may be reduced, and the variation in the liquid discharge characteristics of the device substrates may be reduced so that good image quality may be obtained.

In the following, a liquid discharge head according to a second embodiment of the present invention is described with reference to FIG. 5. It is noted that in this drawing, components that are identical to those of the first embodiment are assigned the same numerical references.

FIG. 5 is a diagram showing the surface of the device substrates of the liquid discharge head according to the present embodiment on which surface liquid discharge outlets are formed. It is noted that the structure of the liquid discharge head according to the present embodiment is identical to that of the liquid discharge head 1 according to the first embodiment except for the number of outlet rows provided on the device substrate 3. The device substrate 3 according to the present embodiment is also divided into two device substrates 3a and 3b.

According to the present embodiment, the device substrate 3a includes outlet rows 21Bk, 22Bk, 21R, 22R, 21C, 22C, 21PC, and 22PC that are arranged to discharge inks corresponding to black (Bk), red (R), cyan (C), and photo cyan (PC), respectively. The device substrate 3b includes outlet rows 21Y, 22Y, 21PM, 22PM, 21M, 22M, 21B, and 22B that are arranged to discharge inks corresponding to yellow (Y), photo magenta (PM), magenta (M), and blue (B), respectively.

According to the present embodiment, inks corresponding to red (R) and blue (B) are used in addition to the six colors of ink used in the first embodiment. It is noted that by adding the red (R) ink, the color of the human skin may be better represented, and by adding the blue (B) ink, the color of the sea or the sky may be better represented, for example, so that photographic images may be output with good image quality.

Table 2 shown below indicates the ink colors of the outlet rows 21 of the device substrates 3a and 3b of the liquid discharge head of the present embodiment, and the inks used in a document output operation and a photograph output operation according to the present embodiment.

TABLE 2

| | Device Substrate 3a | | | | Device Substrate 3b | | | |
|---|---|---|---|---|---|---|---|---|
| Outlet Row Ink Color | Bk | R | C | PC | Y | PM | M | B |
| Document Output | ◯ | — | ◯ | — | ◯ | — | ◯ | — |
| Photograph Output | ◯ | ◯ | ◯ | ◯ | ◯ | ◯ | ◯ | ◯ |

◯: used, —: not used

According to the present embodiment, the same number of inks is used at the device substrates 3a and 3b for the document output operation and the same number of inks is used at the device substrates 3a and 3b for the photograph output operation. The inks only used in the photograph output operation (i.e., R, PC, PM, and B) are equally allocated to the device substrates 3a and 3b so that the same number of inks used only in the photograph output operation is provided at the device substrates 3a and 3b.

In this way, the temperature difference in the device substrates 3a and 3b that are heated by the heat generated from driving the liquid discharge head may be reduced, and the occurrence of a variation in the liquid discharge characteristics of the device substrates 3a and 3b due to the temperature difference may be prevented so that good image quality may be obtained.

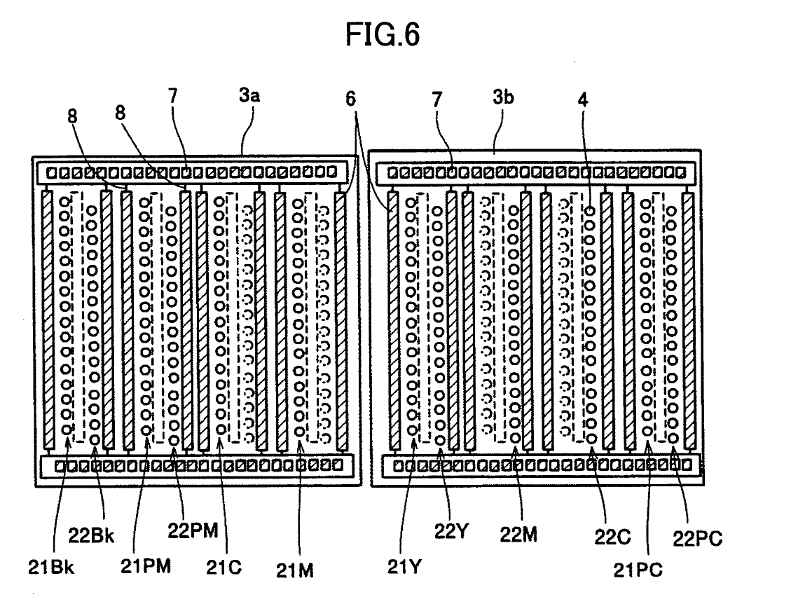

In the following a liquid discharge head according to a modified embodiment is described with reference to FIG. 6.

FIG. 6 is a diagram showing the surfaces of device substrates of the liquid discharge head according to the modified embodiment on which surfaces discharge outlets are formed. On the device substrates 3a and 3b of FIG. 6, ink types are assigned to the outlet rows 21 and 22 in a manner such that coloring irregularities may be prevented in a back-and-forth scan printing operation. According to the present embodiment, the outlet rows 21M and 21C for discharging magenta (M) ink and cyan (C) ink, respectively, are arranged on the device substrate 3a side of the outlet rows 21Y and 22Y for discharging yellow (Y) ink, and outlet rows 22M and 22C for discharging magenta (M) ink and cyan (C) ink are arranged on the device substrate 3b side of the outlet rows 21Y and 22Y. In this arrangement, the same number of ink types is used at the device substrates 3a and 3b for each output operation, and the same number of ink types only used in the photograph output operation is assigned to the device substrates 3a and 3b.

It is noted that according to the present embodiment, outlet rows 22M and 22C are not used in the device substrate 3a, and outlet rows 21M and 21C are not used in the device substrate 3b (the corresponding virtual outlet rows being indicated by dotted lines in FIG. 6).

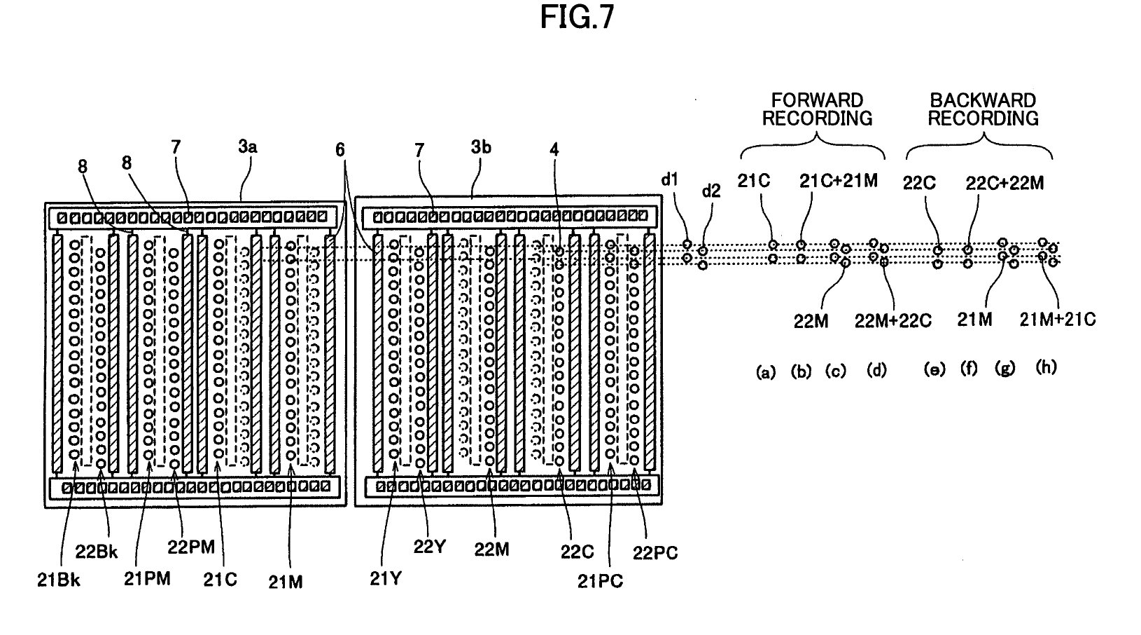

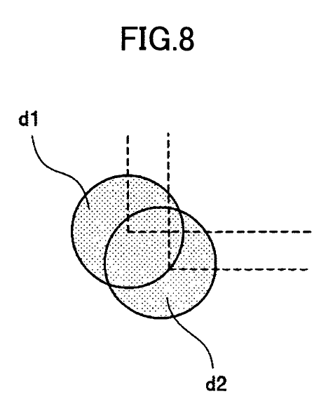

In the following, an exemplary recording method using the liquid discharge head of FIG. 6 is described with reference to FIGS. 7 and 8.

According to the present example, when a primary color such as magenta is to be printed to form an image, magenta ink droplets are discharged onto dot positions d1 and d2 from the magenta discharge outlet rows 21M and 22M, respectively, without regard to the scanning direction. In this case, since the discharged droplets are of the same color, a difference in color development is not created by a difference in the order of discharging the ink droplets from the discharge outlet rows 21 and 22.

On the other hand, when a secondary color such as blue is to be printed, cyan ink and magenta ink are used to print one pixel, and thereby, ink droplets are discharged from the discharge outlet rows 21C (cyan), 21M (magenta), 22C (cyan), and 22M (magenta), respectively, to form each pixel.

In this case, when recording is conducted in a forward direction (forward scanning), the discharge outlet rows of the liquid discharge head passes a predetermined position of the recording medium in the following order: 21C→21M→22M 22C, and thereby, ink droplets are discharged on the recording medium in a manner as is illustrated by (a)˜(d) in FIG. 7. As is shown, at the dot position d1, the ink droplets are discharged in the order of C→M, and thereby, cyan that is applied first may be predominant. On the other hand, at the dot position d2, the ink droplets are discharged in the order of M→C, and thereby, magenta that is applied first may be predominant.

When recording is conducted in a backward direction (backward scanning), the discharge outlet rows of the ink discharge head pass a predetermined position of the recording medium in the following order: 22C→22M→21M>21C, and thereby, ink droplets are discharged on the recording medium in a manner as is illustrated by (e)˜(f) in FIG. 7. At the dot position d1, the ink droplets are discharged in the order of M→C, and thereby, magenta that is applied first may be predominant. On the other hand, at dot position d2, the ink droplets are discharged in the order of C→M, and thereby, cyan that is applied first may be predominant.

As is described above, according to the present example, a dot with cyan predominance and a dot with magenta predominance come in pairs regardless of the scanning direction so that the printed pixel may have a neutral blue color.

FIG. 8 is a diagram illustrating a state in which the dot positions d1 and d2 overlap. As is shown in this drawing, in practice, the dot positions d1 and d2 overlap so that in forward recording, first, a cyan dot is formed by an ink droplet discharged from the discharge outlet row 21C, then a magenta dot is formed by an ink droplet discharged from the discharge outlet row 21M, then a magenta dot is formed by an ink droplet discharged from the discharge outlet row 22M, and then a cyan dot is formed by an ink droplet discharged by the discharge outlet row 22C. In backward recording, first, a cyan dot is formed by an ink droplet discharged from the discharge outlet row 22C, then a magenta dot is formed by an ink droplet discharged by the discharge outlet row 22M, then a magenta dot is formed by an ink droplet discharged from the discharge outlet row 21M, and then a cyan dot is formed by an ink droplet discharged from the discharge outlet row 21C.

As is described above, the discharging order of ink droplets for forward recording and backward recording is arranged to be asymmetrical, and the order in which the colors are applied is arranged to be the same so that an even blue color may be realized. Accordingly, the generation of irregularities in the color distribution may be prevented. It is noted that the present arrangement may be equally applied to other color ink combinations including combinations of light (photo) ink to prevent the generation of irregularities in the color distribution from back-and-forth printing.

It is noted that the recording method as is described above is merely one exemplary method for realizing back-and-forth printing using the liquid discharge head of the present embodiment, and an image forming method using the liquid discharge head of the present embodiment is not limited to this example.

By arranging the color dots formed by forward scanning and backward scanning to be symmetrical with respect to the center, color irregularities may be prevented, and back-and-forth printing with high speed and good image quality may be realized.

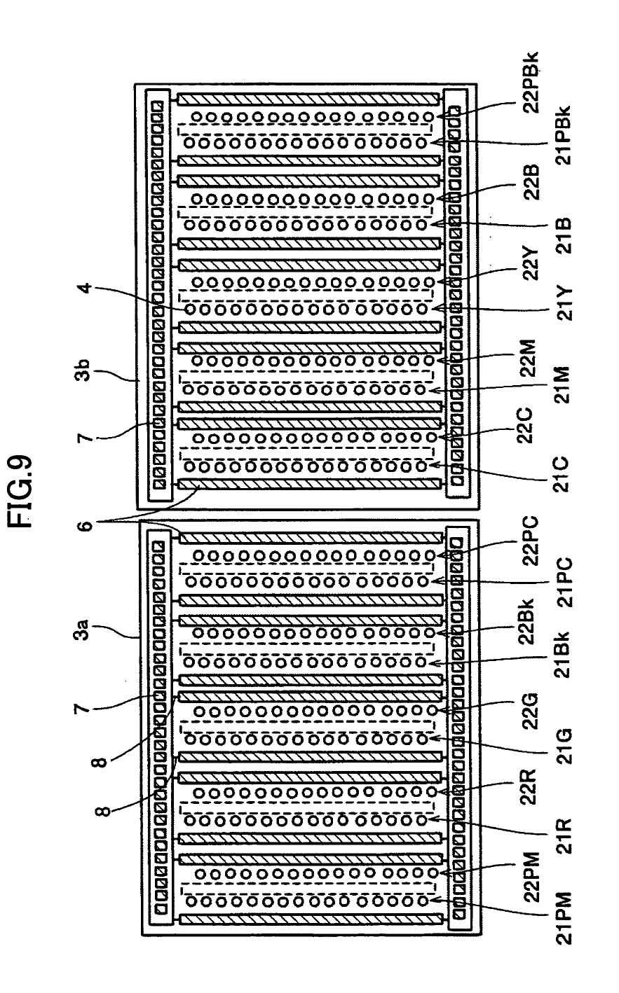

In the following, a liquid discharge head according to a third embodiment of the present invention is described with reference to FIG. 9.

FIG. 9 is a diagram showing the surfaces of device substrates of the liquid discharge head of the present embodiment on which surfaces discharge outlets are formed.

It is noted that the overall structure of the liquid discharge head according to the present embodiment is identical to that described in relation to the first embodiment. The device substrate is also divided into device substrates 3a and 3b in the present embodiment.

The device substrate 3a includes discharge outlet rows 21PM, 22PM, 21R, 22R, 21G, 22G, 21Bk, 22Bk, 21PC, and 22PC for discharging inks corresponding to photo magenta (PM), red (R), green (G), black (Bk), and photo cyan (PC), respectively.

The device substrate 3b includes discharge outlet rows 21C, 22C, 21M, 22M, 21Y, 22Y, 21B, 22B, 21PBk, and 22PBk for discharging inks corresponding to cyan (C), magenta (M), yellow (Y), blue (B), and photo black (PBk), respectively.

According to the present embodiment, inks corresponding to green (G) and photo black (PBk) are used in addition to the inks used in the second embodiment as is described above. In other words, ten different types of inks are used in the present embodiment. By adding the green ink, the liquid discharge head of the present embodiment may be arranged to output the three primary colors R, G, and B so as to output a photographic image with good image quality. According to the present embodiment, the colors red (R), green (G), and blue (B) that are conventionally represented by a combination of two of the color inks yellow (Y), magenta (M), and cyan (C) may be represented by a single color ink. Also, by adding photo black (PBk) ink that is thinner (in concentration) than black (Bk) ink, a color that is conventionally represented by a combination of the three color inks yellow (Y), magenta (M), and cyan (C) may be represented by a single color ink (i.e., photo black (PBk)). Thereby, the amount of ink used may be reduced and the applied ink may dry faster so that the printed image may be prevented from penetrating to the other side of the recording medium and curling and cockling of the recording medium may be prevented.

Table 3 as is shown below indicates the ink colors assigned to the discharge outlet rows of the device substrates 3a and 3b of the liquid discharge head of the present embodiment, and the respective inks used in a document output operation and a photograph output operation according to the present embodiment.

TABLE 3

| Outlet Row | Device Substrate 3a | | | | | Device Substrate 3b | | | | |
|---|---|---|---|---|---|---|---|---|---|---|
| Ink Color | PM | R | G | Bk | PC | C | M | Y | B | PBk |
| Document Output | — | ◯ | ◯ | ◯ | — | ◯ | — | ◯ | ◯ | — |
| Photograph Output | ◯ | ◯ | ◯ | — | ◯ | ◯ | ◯ | ◯ | ◯ | ◯ |

◯: used, —: not used

According to the present embodiment, the number of types of inks used in the two device substrates 3a and 3b are not the same. However, the difference in the number of ink types used in the two device substrates 3a and 3b is arranged to be no more than one. It has been discovered that when at least five different types of inks are provided in each device substrate, a difference of one in the number of ink types used in the device substrates may not be a significant factor influencing the temperature of the device substrates.

According to the present invention, in each of a document output operation and a photograph output operation, the number of ink types used in the device substrates 3a and 3b is substantially the same (the difference being no more than one), and thereby, when the device substrates 3a and 3b are heated by the heat generated by driving the liquid discharge head, the occurrence of a temperature difference between the device substrates 3a and 3b may be prevented, and a variation in the liquid discharge characteristics between the device substrates 3a and 3b may be avoided so that good image quality may be obtained. Also, according to the present embodiment, the difference in the number of ink types only used in a photograph output operation (including a gradation image output) at the device substrates 3a and 3b is arranged to be no more than one.

As is described above, by providing discharge outlet rows for discharging at least five types of ink on each device substrate, and arranging the difference in the number of ink types to be used at the device substrates in each image output operation to be no more than one, color reproducibility may be improved from using a wide range of colors, and the amount of ink used may be reduced by the decrease in the number of cases in which plural types of ink have to be combined. Also, the occurrence of a temperature difference between the device substrates may be avoided in a case where the device substrates are heated by the heat generated upon driving the liquid discharge head, and a variation in the liquid discharge characteristics between the device substrates may be avoided so that good image quality may be obtained.

Also, by providing discharge outlet rows for discharging at least five types of ink on each device substrate, and arranging the difference in the number of ink types only used at the device substrates in a particular image output operation to be no more than one, color reproducibility may be improved from using a wide range of colors, and the amount of ink used may be reduced by the decrease in the number of cases in which plural types of ink have to be combined. Also, the occurrence of a temperature difference between the device substrates may be avoided in a case where the device substrates are heated by the heat generated upon driving the liquid discharge head, and a variation in the liquid discharge characteristics between the device substrates may be avoided so that good image quality may be obtained.

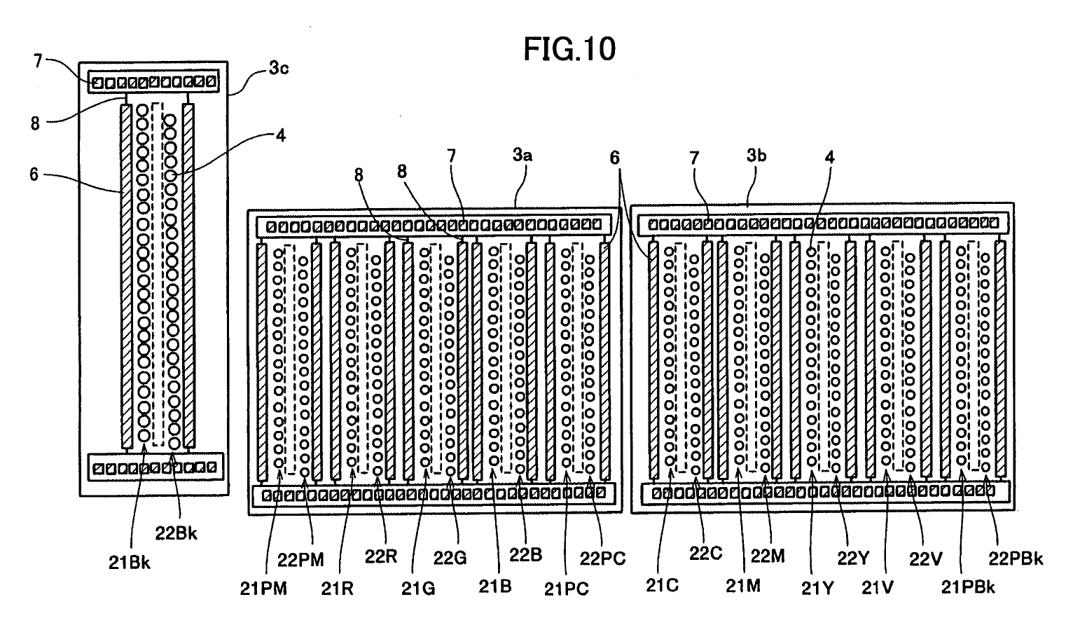

In the following, a liquid discharge head according to a fourth embodiment of the present invention is described with reference to FIG. 10.

FIG. 10 is a diagram showing surfaces of device substrates 3a, 3b, and 3c of the liquid discharge head of the present embodiment on which surfaces discharge outlets are formed.

It is noted that the overall structure of the liquid discharge head of the present embodiment is identical to that described in relation to the first embodiment. However, in the present embodiment, the device substrate is divided into three device substrates 3a, 3b, and 3c.

According to the present embodiment, the device substrate 3a includes discharge outlet rows 21PM, 22PM, 21R, 22R, 21G, 22G, 21B, 22B, 21PC, and 22PC for discharging inks corresponding to photo magenta (PM), red (R), green (G), blue (B), and photo cyan (PC), respectively.

The device substrate 3b includes discharge outlet rows 21C, 22C, 21M, 22M, 21B, 22B, 21V, 22V, 21PBk, and 22PBk for discharging inks corresponding to cyan (C), magenta (M), yellow (Y), violet (V), and photo black (PBk), respectively.

The device substrate 3c includes discharge outlet rows 21Bk and 22Bk for discharging black (Bk) ink.

According to the present embodiment, pigment ink with a thick concentration is used as black (Bk) ink so that characters and graphics may be clearly printed, and dye ink is used for the inks other than black (Bk) ink. The discharge outlet rows 21Bk and 22Bk for discharging black (Bk) ink are provided with a large number of discharge outlets with a large diameter so that a document output operation may be realized with high speed.

Table 4 as is shown below indicates the types of inks assigned to the discharge outlet rows of the device substrates 3a, 3b, and 3c of the liquid discharge head of the present embodiment, and the ink types used in a document output operation and a photograph output operation according to the present embodiment.

TABLE 4

| | Device Substrate 3a | | | | | Device Substrate 3b | | | | | 3c |
|---|---|---|---|---|---|---|---|---|---|---|---|
| Ink Color | PM | R | G | B | PC | C | M | Y | V | PBk | Bk |
| Document | — | ◯ | ◯ | ◯ | — | ◯ | ◯ | ◯ | — | — | ◯ |
| Output | | | | | | | | | | | |
| Photograph | ◯ | ◯ | ◯ | ◯ | ◯ | ◯ | ◯ | ◯ | ◯ | ◯ | — |
| Output | | | | | | | | | | | |

◯: used, —: not used

According to the present embodiment, the same number of ink types is used in the substrates 3a and 3b for each of a document output operation and a photograph output operation. It is noted that the device substrate 3c is provided with only one color, i.e., black (Bk) ink, for printing text and graphics. Since this ink usually does not mix with other color inks, it may not be a significant factor influencing the image quality of the output image.

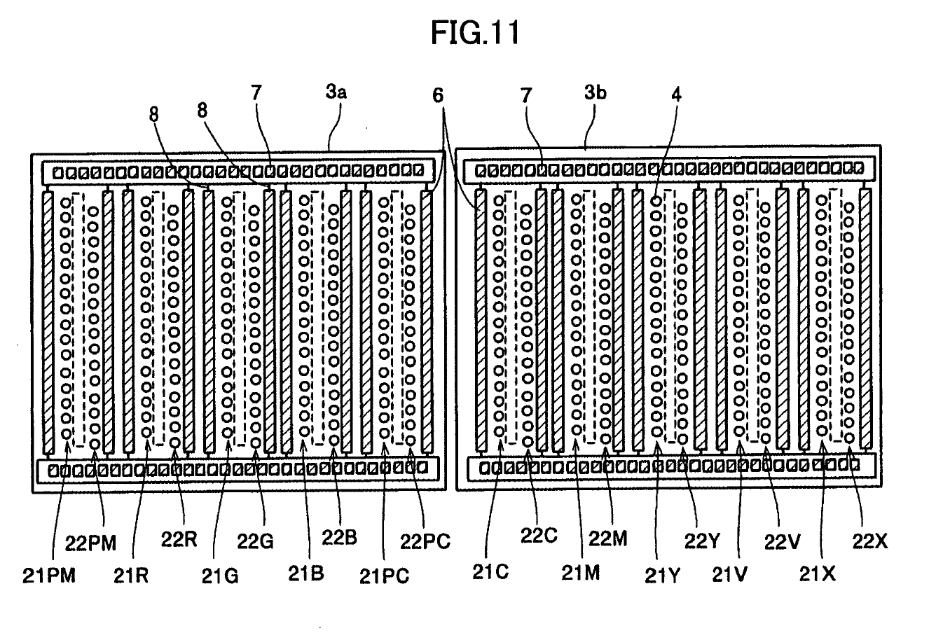

In the following a liquid discharge head according to a fifth embodiment of the present invention is described with reference to FIG. 11.

FIG. 11 is a diagram showing surfaces of device substrates 3a and 3b of the liquid discharge head according to the present embodiment on which surfaces discharge outlets are formed.

It is noted that the overall structure of the liquid discharge head according to the present embodiment is identical to that described in relation to the first embodiment. In the present embodiment, the device substrate is divided into two substrates 3a and 3b.

The device substrate 3a includes discharge outlet rows 21PM, 22PM, 21R, 22R, 21G, 22G, 21Bk, 22Bk, 21PC, and 22PC for discharging inks corresponding to photo magenta (PM), red (R), green (G), black (Bk), and photo cyan (PC), respectively.

The device substrate 3b includes discharge outlet rows 21C, 22C, 21M, 22M, 21Y, 22Y, 21V, 22V, 21X, and 22X for discharging inks corresponding to cyan (C), magenta (M), yellow (Y), blue (B), and transparent (X), respectively.

The inks used in the ink discharge head of the present embodiment correspond to pigment ink. By using pigment ink, colors may be prevented from running or blurring when printing on normal recording paper, and color fading of the printed image over time may be prevented. It is noted that since pigment ink cannot represent glossiness, it may not be suitable for printing on photographic glossy paper. In this regard, according to the present embodiment, transparent (X) ink is added, and this transparent (X) ink is used to represent highlighted portions of an image and other portions in which little ink is used so that the printed surface may be evened out, and diffused reflection of light may be prevented. In this way, an image may be suitably output on glossy paper.

Also, it is noted that the transparent (X) ink may be used for purposes other than glossy paper printing. For example, the transparent (X) ink may be applied on a recording medium before or after the color ink is applied in order to prevent color running and to suitably fix the printed image on the recording medium.

Table 5 as is shown below indicates the ink colors assigned to discharge outlet rows of the device substrates 3a and 3b of the liquid discharge head according to the present embodiment, and the inks used in a document output operation and a photograph output operation according to the present embodiment.

TABLE 4

| | Device Substrate 3a | | | | | Device Substrate 3b | | | | |
|---|---|---|---|---|---|---|---|---|---|---|
| Ink Color | PM | R | G | Bk | PC | C | M | Y | B | X |
| Document Output | — | ◯ | ◯ | ◯ | — | ◯ | ◯ | ◯ | — | — |
| Photograph Output | ◯ | ◯ | ◯ | ◯ | ◯ | ◯ | ◯ | ◯ | ◯ | ◯ |

◯: used, —: not used

According to the present embodiment, the same number of inks is used in the device substrates 3a and 3b for the document output operation and the same number of inks is used in the device substrates 3a and 3b for the photograph output operation.

It is noted that in the embodiments described above, the number of ink types and their arrangement have been specifically indicated. However, the present invention is not limited to the above embodiments, and the types and number of inks used, and their arrangement and combinations may be varied from the above described embodiments. For example, inks (recording liquid) corresponding to white, gold, and/or silver may be used as well.

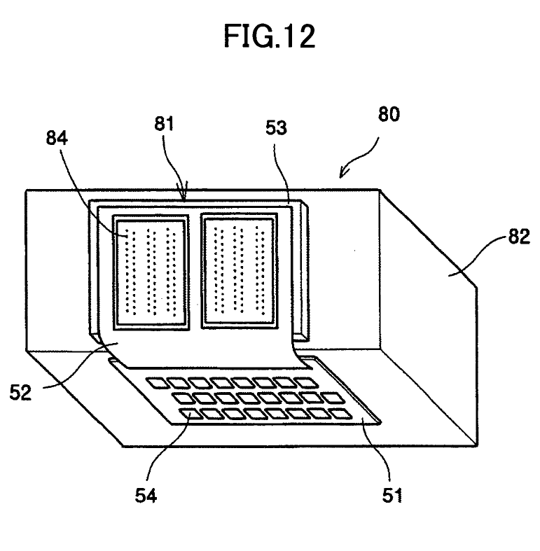

In the following, a liquid cartridge according to an embodiment of the present invention is described with reference to FIG. 12.

FIG. 12 is a perspective view of the liquid cartridge according to the present embodiment. The liquid cartridge 80 shown in FIG. 12 includes a liquid discharge head 81 with discharge outlets 84 that may correspond to one of the liquid discharge heads according to the first through fifth embodiments described above, and a liquid container 82 that stores liquid to be supplied to the liquid discharge head 81. It is noted that the liquid container 82 may be refilled with liquid and reused after the liquid stored therein is consumed.

By implementing a liquid discharge head according to an embodiment of the present invention in a liquid cartridge as is described above, the occurrence of a variation in ink discharge characteristics may be prevented and a liquid cartridge capable of high frequency discharge may be realized.

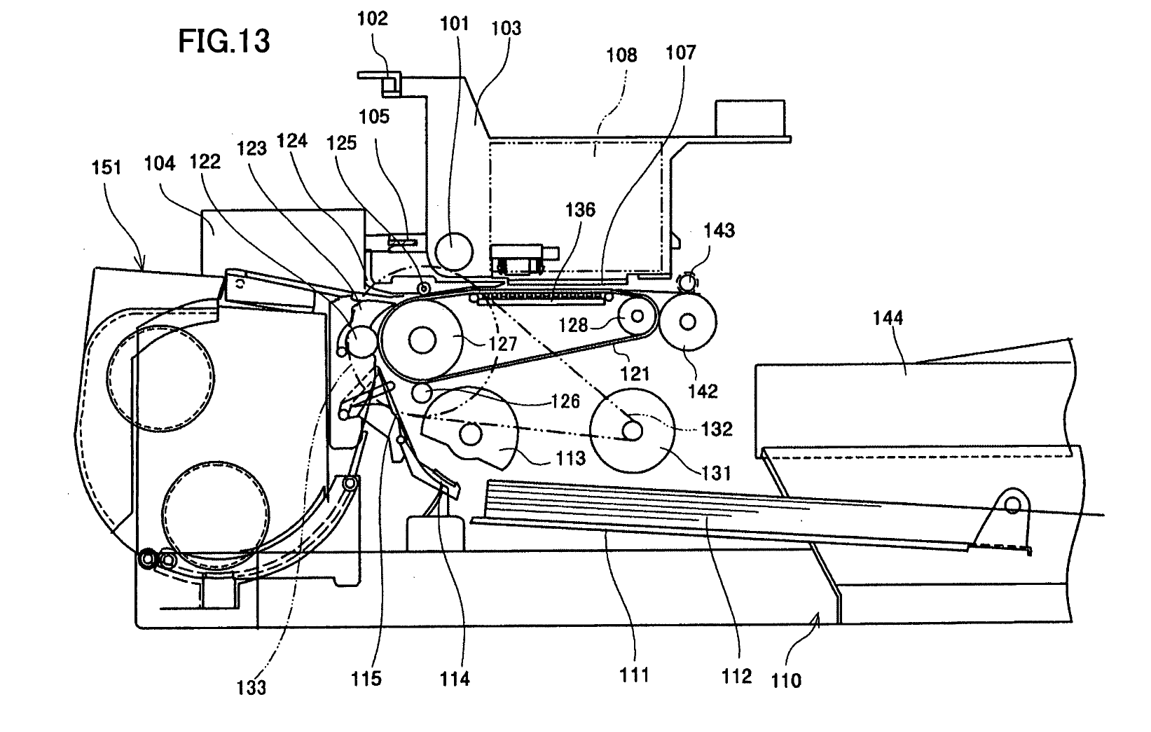

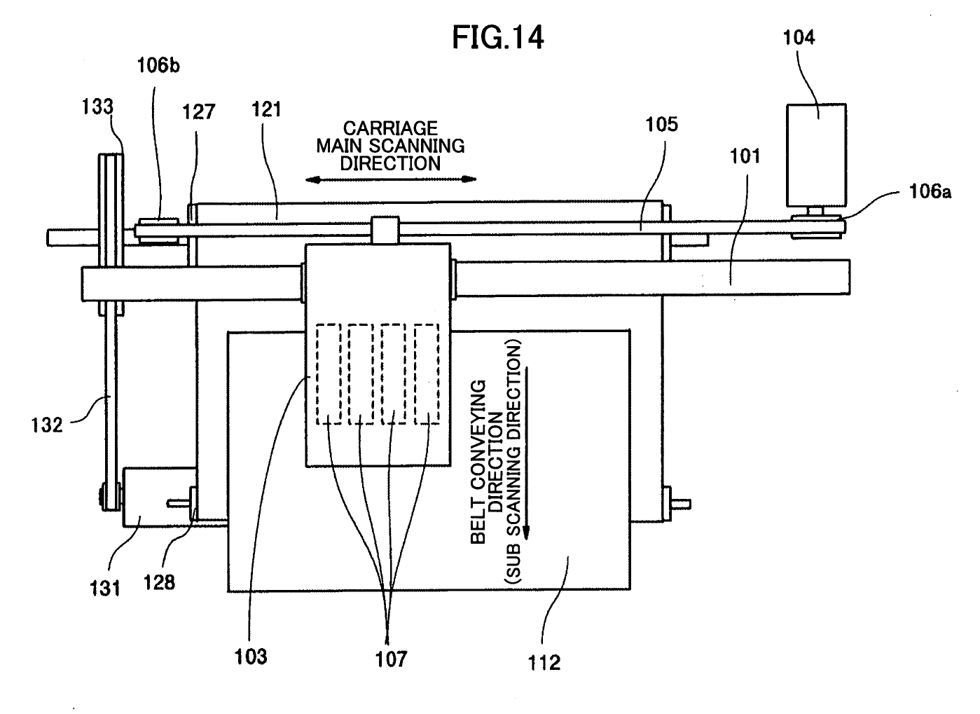

In the following, a liquid discharge apparatus according to an embodiment of the present invention is described with reference to FIGS. 13 and 14.

FIG. 13 is a diagram showing an overall configuration of an imaging apparatus as an embodiment of a liquid discharge apparatus of the present invention. FIG. 14 is a plan view of the imaging apparatus of the present embodiment.

The imaging apparatus of the present embodiment includes a guide rod 101 and a stay 102 corresponding to a guide member held between left and right side boards (not shown) of the apparatus and slidably supporting a carriage 103 to enable the carriage 103 to move along a main scanning direction. The carriage 103 is engaged to a timing belt 105 that is held between a pulley 106a attached to a main scanning motor 104 and a pulley 106b positioned on the other side of the pulley 106a, and the carriage 103 is moved in a carriage main scanning direction (see FIG. 14) by the main scanning motor 104 via the timing belt 105.

The carriage 103 includes an ink jet head 107 corresponding to a liquid discharge head according to an embodiment of the present invention, the ink jet head 107 being arranged to discharge inks corresponding to yellow (Y), cyan (C), magenta (M), black (Bk), photo cyan (PC), photo magenta (PM), photo black (PBk), red (R), green (G), and blue (B), for example. The ink jet head 107 has plural discharge outlet rows that are arranged across the main scanning direction, and the discharge outlets are arranged such that the ink discharging direction is directed downward.

The carriage 103 includes sub tanks 108 for supplying ink corresponding to the respective ink colors provided in the imaging apparatus. The sub tank 108 is connected to a main tank (ink cartridge) via an ink supply tube (not shown) so that ink may be supplied from the main tank to the sub tank 108. It is noted that a liquid cartridge that is integrated with a liquid discharge head according to an embodiment of the present invention as is described above may be used as well.

The imaging apparatus of the present embodiment also includes a paper feeding unit for feeding paper 112 stacked on a paper stacking unit 111 of a paper feeding cassette 110, the paper feeding unit including a paper feed roller 113 for separating and feeding paper 112 from the paper stacking unit 111 one sheet at a time, and a separating pad 114 facing the paper feed roller 113. The separating pad 114 is made of a material having a greater friction coefficient compared to that of the paper feed roller 113, and is urged toward the paper feeding roller 113.

Also, the imaging apparatus of the present embodiment includes a conveying unit for conveying the sheet of paper 112 that is fed from the paper feeding unit. The conveying unit includes a conveying belt 121 that conveys the paper 112 through electrostatic adhesion, a counter roller 122 that is arranged to hold the paper 112 carried from the paper feeding unit via a guide 115 between the conveying belt 121, a conveying guide 123 that is arranged to change the direction of the paper 112 by approximately 90 degrees to direct the paper 112 being carried vertically to a horizontal direction along the conveying belt 121, a tip pressure roller 125 that is urged toward the conveying belt 121 by a push member 124, and a charge roller 126 that statically charges a surface of the conveying belt 121.

The conveying belt 121 is arranged into a continuous belt having no ends, and is supported between a conveying roller 127 and a tension roller 128. The conveying belt 121 is arranged to move around the conveying roller 127 and the tension roller 128 in a belt conveying direction (sub scanning direction) in response to the rotation of the conveying roller 127 that is rotated by a sub scanning motor 131 via a timing belt 132 and a timing roller 133.

The conveying belt 121 includes a surface layer corresponding to a paper sheet adhering surface that is made of pure resin material on which rheostatic control is not conducted such as ETFE pure material, the surface layer having a thickness of approximately 40 μm, and a rear face layer (middle resistance layer, earth layer) that is made of the same material as the surface layer on which layer material rheostatic control is conducted by carbon.

The charge roller 126 is held in contact with the surface layer of the conveying belt 121, and is arranged to rotate according to the rotation of the conveying belt 121. A pressure of 2.5 N is applied to each axial end of the charge roller 126. The conveying roller 127 also functions as an earth roller and is held in contact with the middle resistance layer (rear face layer) of the conveying belt 121 so as to be grounded.

At the rear side of the conveying belt 121, a guide member 136 is provided at a region corresponding to a printing region of the ink jet head 107. It is noted that the upper surface of the guide member 136 is arranged to be slightly raised toward the ink jet head 107 side with respect to the tangential line of the conveying belt 121 being supported by the two rollers (i.e., conveying roller 127 and tension roller 128). Accordingly, the conveying belt 121 may be raised and guided by the upper surface of the guide member 136 at the printing region.

Also, it is noted that the imaging apparatus according to the present invention includes a paper delivery unit for delivering paper 112 having an image recorded thereon by the ink jet head 107. The paper delivery unit includes a separating unit for separating the paper 112 from the conveying belt 121, a paper delivery roller 142, a paper delivery counter roller 143, and a paper delivery tray 144 that stocks the paper 112 delivered from the paper delivery unit. The imaging apparatus also includes a dual side printing unit 151 that is detachably provided at the back side of the apparatus. The dual side printing unit 151 is arranged to receive the paper 112 that is moved backwards by a reverse rotation of the conveying belt 121, flip the paper 112, and re-feed the paper 112 between the counter roller 122 and the conveying belt 121.

In the imaging apparatus according to the present embodiment, the paper 112 is fed to the apparatus from the paper feeding unit one sheet at a time, and the paper 112 being carried in a vertical direction from the paper feeding unit is guided by the guide 115 to be held between the conveying belt 121 and the counter roller 122 and conveyed along the conveying belt 121. Further, the tip of the paper 112 is guided by the conveying guide 123 and is pressed to the conveying belt 121 by the tip pressure roller 125 so that the conveying direction of the paper 11 may be changed by approximately 90 degrees.

According to the present embodiment, a positive output and a negative output are alternatingly applied to the charge roller 126 from a high voltage power source through control of a control circuit (not shown), and the conveying belt 121 is alternatingly charged by a positive charge and a negative charge to form strips of alternating positive and negative charged regions with predetermined widths (charge voltage patterns) along the rotating direction of the conveying belt 121, i.e., the sub scanning direction. The paper 112 is fed to the conveying belt 121 that is alternatingly charged by a positive charge and a negative charge, and in this way, the paper 112 is statically adhered to the conveying belt 121 and is conveyed in the sub scanning direction by the rotational movement of the conveying belt 121.

According to the present embodiment, an image of one line may be recorded on the paper 112 that is sustained in a still state by driving the ink jet head 107 and discharging ink droplets on the paper 112 according to image signals while moving the carriage 103 in the main scanning direction. Then, the paper 112 may be conveyed in the sub scanning direction by a predetermined distance to record the next image line. The recording operation is stopped upon receiving a recording end signal or a signal indicating that the end of the recording region of the paper 112 has been reached, and the paper 112 is then delivered to the paper delivery tray 144.

As is described above, the imaging apparatus according to the present embodiment implements a liquid discharge head according to an embodiment of the present invention, and thereby, image degradation due to a temperature difference between device substrates may be prevented and high quality image printing may be realized.

It is noted that an imaging apparatus is described above as an embodiment of a liquid discharge apparatus (ink jet recording apparatus); however, the present invention is not limited to this embodiment. For example, materials other than paper may be used as the recording medium on which liquid such as ink is applied, including but not limited to OHP sheets, plastic material that is used on compact disks and decorative boards, textile, metal material such as aluminum or copper, leather material such as oxhide, pig hide, or artificial leather, wood material such as plywood or bamboo, ceramic material such as a tile, and three-dimensional articles such as a sponge.

Also, embodiments of a liquid discharge apparatus of the present invention may include a printer for recording an image on various types of paper and/or OHP sheets, a plastic recording apparatus for recording an image on plastic material such as a compact disk, a metal recording apparatus for recording an image on a metal board, a leather recording apparatus for recording an image on leather material, wood recording apparatus for recording an image on wood material, a ceramic recording apparatus for recording an image on ceramic material, a textile printing apparatus for printing an image on textile material, and a recording apparatus for recording an image on a three-dimensional article such as a sponge, for example.

Also, it is noted that a suitable liquid (recording liquid) may be used in the liquid discharge apparatus according to the recording medium and recording conditions.

Further, the present invention is not limited to the specific embodiments described above, and variations and modifications may be made without departing from the scope of the present invention.

The present application is based on and claims the benefit of the earlier filing date of Japanese Patent Application No. 2004-118730 filed on Apr. 14, 2004, the entire contents of which are hereby incorporated by reference.

1. A liquid discharge head comprising:
a discharge outlet for discharging liquid;
a flow path that is in communication with the discharge outlet and is configured to supply the liquid to the discharge outlet;
a flow path partitioning wall that is arranged between an adjacent pair of the flow paths; and
a plurality of device substrates including at least a first device substrate and a second device substrate, the device substrates including energy generating means for applying energy to the liquid in the liquid flow path and inducing the liquid to be discharged from the discharge outlet; wherein
each of at least the first device substrate and the second device substrate includes a plurality of the discharge outlets for discharging a plurality of types of liquids, at least one of the types of liquids being used for at least one output image and not being used for at least one other output image; and
for each output image, a number of types of liquids used in at least the first device substrate and the second device substrate is arranged to be the same.

2. A liquid discharge head comprising:
a discharge outlet for discharging liquid;
a flow path that is in communication with the discharge outlet and is configured to supply the liquid to the discharge outlet;
a flow path partitioning wall that is arranged between an adjacent pair of the flow paths; and
a plurality of device substrates including at least a first device substrate and a second device substrate, the device substrates including energy generating means for applying energy to the liquid in the liquid flow path and inducing the liquid to be discharged from the discharge outlet; wherein
each of at least the first device substrate and the second device substrate includes a plurality of the discharge outlets for discharging a plurality of types of liquids, at least one of the types of liquids being used for at least one output image and not being used for at least one other output image; and
a number of types of liquids only used for a particular output image in at least the first device substrate and the second device substrate is arranged to be the same.

3. A liquid discharge head comprising:
a discharge outlet for discharging liquid;
a flow path that is in communication with the discharge outlet and is configured to supply the liquid to the discharge outlet;
a flow path partitioning wall that is arranged between an adjacent pair of the flow paths; and
a plurality of device substrates including at least a first device substrate and a second device substrate, the device substrates including energy generating means for applying energy to the liquid in the liquid flow path and inducing the liquid to be discharged from the discharge outlet; wherein
each of at least the first device substrate and the second device substrate includes a plurality of the discharge outlets for discharging at least five types of liquids, at least one of the types of liquids being used for at least one output image and not being used for at least one other output image; and
for each output image, a difference in a number of types of liquids used in at least the first device substrate and the second device substrate is arranged to be no more than one.

4. A liquid discharge head comprising:
a discharge outlet for discharging liquid;
a flow path that is in communication with the discharge outlet and is configured to supply the liquid to the discharge outlet;
a flow path partitioning wall that is arranged between an adjacent pair of the flow paths; and
a plurality of device substrates including at least a first device substrate and a second device substrate, the device substrates including energy generating means for applying energy to the liquid in the liquid flow path and inducing the liquid to be discharged from the discharge outlet; wherein
each of at least the first device substrate and the second device substrate includes a plurality of the discharge outlets for discharging at least five types of liquids, at least one of the types of liquids being used for at least one output image and not being used for at least one other output image; and
a difference in a number of types of liquids only used for a particular output image in at least the first device substrate and the second device substrate is arranged to be no more than one.

5. A liquid cartridge comprising:
a liquid container that stores liquid; and
a liquid discharge head that is in communication with the liquid container and receives the liquid from the liquid container, the liquid discharge head including
a discharge outlet for discharging the liquid;
a flow path that is in communication with the discharge outlet and is configured to supply the liquid to the discharge outlet;
a flow path partitioning wall that is arranged between an adjacent pair of the flow paths; and
a plurality of device substrates including at least a first device substrate and a second device substrate, the device substrates including energy generating means for applying energy to the liquid in the liquid flow path and inducing the liquid to be discharged from the discharge outlet; wherein
each of at least the first device substrate and the second device substrate includes a plurality of the discharge outlets for discharging a plurality of types of liquids, at least one of the types of liquids being used for at least one output image and not being used for at least one other output image; and
for each output image, a number of types of liquids used in at least the first device substrate and the second device substrate is arranged to be the same.

6. A liquid cartridge comprising:
a liquid container that stores liquid; and
a liquid discharge head that is in communication with the liquid container and receives the liquid from the liquid container, the liquid discharge head including
a discharge outlet for discharging liquid;
a flow path that is in communication with the discharge outlet and is configured to supply the liquid to the discharge outlet;
a flow path partitioning wall that is arranged between an adjacent pair of the flow paths; and
a plurality of device substrates including at least a first device substrate and a second device substrate, the device substrates including energy generating means for applying energy to the liquid in the liquid flow path and inducing the liquid to be discharged from the discharge outlet; wherein
each of at least the first device substrate and the second device substrate includes a plurality of the discharge outlets for discharging a plurality of types of liquids, at least one of the types of liquids being used for at least one output image and not being used for at least one other output image; and
a number of types of liquids only used for a particular output image in at least the first device substrate and the second device substrate is arranged to be the same.

7. A liquid cartridge comprising:
a liquid container that stores liquid; and
a liquid discharge head that is in communication with the liquid container and receives the liquid from the liquid container, the liquid discharge head including
a discharge outlet for discharging liquid;
a flow path that is in communication with the discharge outlet and is configured to supply the liquid to the discharge outlet;
a flow path partitioning wall that is arranged between an adjacent pair of the flow paths; and
a plurality of device substrates including at least a first device substrate and a second device substrate, the device substrates including energy generating means for applying energy to the liquid in the liquid flow path and inducing the liquid to be discharged from the discharge outlet; wherein
each of at least the first device substrate and the second device substrate includes a plurality of the discharge outlets for discharging at least five types of liquids, at least one of the types of liquids being used for at least one output image and not being used for at least one other output image; and
for each output image, a difference in a number of types of liquids used in at least the first device substrate and the second device substrate is arranged to be no more than one.

8. A liquid cartridge comprising:
a liquid container that stores liquid; and
a liquid discharge head that is in communication with the liquid container and receives the liquid from the liquid container, the liquid discharge head including
a discharge outlet for discharging liquid;
a flow path that is in communication with the discharge outlet and is configured to supply the liquid to the discharge outlet;
a flow path partitioning wall that is arranged between an adjacent pair of the flow paths; and
a plurality of device substrates including at least a first device substrate and a second device substrate, the device substrates including energy generating means for applying energy to the liquid in the liquid flow path and inducing the liquid to be discharged from the discharge outlet; wherein
each of at least the first device substrate and the second device substrate includes a plurality of the discharge outlets for discharging at least five types of liquids, at least one of the types of liquids being used for at least one output image and not being used for at least one other output image; and
a difference in a number of types of liquids only used for a particular output image in at least the first device substrate and the second device substrate is arranged to be no more than one.

9. A liquid discharge apparatus comprising:
a liquid discharge head including
a discharge outlet for discharging liquid;
a flow path that is in communication with the discharge outlet and is configured to supply the liquid to the discharge outlet;
a flow path partitioning wall that is arranged between an adjacent pair of the flow paths; and
a plurality of device substrates including at least a first device substrate and a second device substrate, the device substrates including energy generating means for applying energy to the liquid in the liquid flow path and inducing the liquid to be discharged from the discharge outlet; wherein
each of at least the first device substrate and the second device substrate includes a plurality of the discharge outlets for discharging a plurality of types of liquids, at least one of the types of liquids being used for at least one output image and not being used for at least one other output image; and
for each output image, a number of types of liquids used in at least the first device substrate and the second device substrate is arranged to be the same.

10. A liquid discharge apparatus comprising:
a liquid discharge head including
a discharge outlet for discharging liquid;
a flow path that is in communication with the discharge outlet and is configured to supply the liquid to the discharge outlet;
a flow path partitioning wall that is arranged between an adjacent pair of the flow paths; and
a plurality of device substrates including at least a first device substrate and a second device substrate, the device substrates including energy generating means for applying energy to the liquid in the liquid flow path and inducing the liquid to be discharged from the discharge outlet; wherein
each of at least the first device substrate and the second device substrate includes a plurality of the discharge outlets for discharging a plurality of types of liquids, at least one of the types of liquids being used for at least one output image and not being used for at least one other output image; and
a number of types of liquids only used for a particular output image in at least the first device substrate and the second device substrate is arranged to be the same.

11. A liquid discharge apparatus comprising:
a liquid discharge head including
a discharge outlet for discharging liquid;
a flow path that is in communication with the discharge outlet and is configured to supply the liquid to the discharge outlet;
a flow path partitioning wall that is arranged between an adjacent pair of the flow paths; and
a plurality of device substrates including at least a first device substrate and a second device substrate, the device substrates including energy generating means for applying energy to the liquid in the liquid flow path and inducing the liquid to be discharged from the discharge outlet; wherein
each of at least the first device substrate and the second device substrate includes a plurality of the discharge outlets for discharging at least five types of liquids, at least one of the types of liquids being used for at least one output image and not being used for at least one other output image; and
for each output image, a difference in a number of types of liquids used in at least the first device substrate and the second device substrate is arranged to be no more than one.

12. A liquid discharge apparatus comprising:
a liquid discharge head including
a discharge outlet for discharging liquid;
a flow path that is in communication with the discharge outlet and is configured to supply the liquid to the discharge outlet;
a flow path partitioning wall that is arranged between an adjacent pair of the flow paths; and
a plurality of device substrates including at least a first device substrate and a second device substrate, the device substrates including energy generating means for applying energy to the liquid in the liquid flow path and inducing the liquid to be discharged from the discharge outlet; wherein
each of at least the first device substrate and the second device substrate includes a plurality of the discharge outlets for discharging at least five types of liquids, at least one of the types of liquids being used for at least one output image and not being used for at least one other output image; and
a difference in a number of types of liquids only used for a particular output image in at least the first device substrate and the second device substrate is arranged to be no more than one.

13. An imaging apparatus that forms an image by discharging liquid from a recording head, the apparatus comprising:
a liquid discharge head including
a discharge outlet for discharging liquid;
a flow path that is in communication with the discharge outlet and is configured to supply the liquid to the discharge outlet;
a flow path partitioning wall that is arranged between an adjacent pair of the flow paths; and
a plurality of device substrates including at least a first device substrate and a second device substrate, the device substrates including energy generating means for applying energy to the liquid in the liquid flow path and inducing the liquid to be discharged from the discharge outlet; wherein
each of at least the first device substrate and the second device substrate includes a plurality of the discharge outlets for discharging a plurality of types of liquids, at least one of the types of liquids being used for at least one output image and not being used for at least one other output image; and
for each output image, a number of types of liquids used in at least the first device substrate and the second device substrate is arranged to be the same.

14. An imaging apparatus that forms an image by discharging liquid from a recording head, the apparatus comprising:
a liquid discharge head including
a discharge outlet for discharging liquid;
a flow path that is in communication with the discharge outlet and is configured to supply the liquid to the discharge outlet;
a flow path partitioning wall that is arranged between an adjacent pair of the flow paths; and
a plurality of device substrates including at least a first device substrate and a second device substrate, the device substrates including energy generating means for applying energy to the liquid in the liquid flow path and inducing the liquid to be discharged from the discharge outlet; wherein
each of at least the first device substrate and the second device substrate includes a plurality of the discharge outlets for discharging a plurality of types of liquids, at least one of the types of liquids being used for at least one output image and not being used for at least one other output image; and
a number of types of liquids only used for a particular output image in at least the first device substrate and the second device substrate is arranged to be the same.

15. An imaging apparatus that forms an image by discharging liquid from a recording head, the apparatus comprising:
a liquid discharge head including
a discharge outlet for discharging liquid;
a flow path that is in communication with the discharge outlet and is configured to supply the liquid to the discharge outlet;
a flow path partitioning wall that is arranged between an adjacent pair of the flow paths; and
a plurality of device substrates including at least a first device substrate and a second device substrate, the device substrates including energy generating means for applying energy to the liquid in the liquid flow path and inducing the liquid to be discharged from the discharge outlet; wherein
each of at least the first device substrate and the second device substrate includes a plurality of the discharge outlets for discharging at least five types of liquids, at least one of the types of liquids being used for at least one output image and not being used for at least one other output image; and
for each output image, a difference in a number of types of liquids used in at least the first device substrate and the second device substrate is arranged to be no more than one.

16. An imaging apparatus that forms an image by discharging liquid from a recording head, the apparatus comprising:
a liquid discharge head including
a discharge outlet for discharging liquid;
a flow path that is in communication with the discharge outlet and is configured to supply the liquid to the discharge outlet;
a flow path partitioning wall that is arranged between an adjacent pair of the flow paths; and
a plurality of device substrates including at least a first device substrate and a second device substrate, the device substrates including energy generating means for applying energy to the liquid in the liquid flow path and inducing the liquid to be discharged from the discharge outlet; wherein
each of at least the first device substrate and the second device substrate includes a plurality of the discharge outlets for discharging at least five types of liquids, at least one of the types of liquids being used for at least one output image and not being used for at least one other output image; and
a difference in a number of types of liquids only used for a particular output image in at least the first device substrate and the second device substrate is arranged to be no more than one.

17. An imaging apparatus that forms an image by discharging liquid from a recording head, the apparatus comprising:
a liquid cartridge including
a liquid container that stores liquid; and
a liquid discharge head that is in communication with the liquid container and receives the liquid from the liquid container, the liquid discharge head including
a discharge outlet for discharging the liquid;
a flow path that is in communication with the discharge outlet and is configured to supply the liquid to the discharge outlet;
a flow path partitioning wall that is arranged between an adjacent pair of the flow paths; and
a plurality of device substrates including at least a first device substrate and a second device substrate, the device substrates including energy generating means for applying energy to the liquid in the liquid flow path and inducing the liquid to be discharged from the discharge outlet; wherein
each of at least the first device substrate and the second device substrate includes a plurality of the discharge outlets for discharging a plurality of types of liquids, at least one of the types of liquids being used for at least one output image and not being used for at least one other output image; and
for each output image, a number of types of liquids used in at least the first device substrate and the second device substrate is arranged to be the same.

18. An imaging apparatus that forms an image by discharging liquid from a recording head, the apparatus comprising:
a liquid cartridge including
a liquid container that stores liquid; and
a liquid discharge head that is in communication with the liquid container and receives the liquid from the liquid container, the liquid discharge head including
a discharge outlet for discharging liquid;
a flow path that is in communication with the discharge outlet and is configured to supply the liquid to the discharge outlet;
a flow path partitioning wall that is arranged between an adjacent pair of the flow paths; and
a plurality of device substrates including at least a first device substrate and a second device substrate, the device substrates including energy generating means for applying energy to the liquid in the liquid flow path and inducing the liquid to be discharged from the discharge outlet; wherein
each of at least the first device substrate and the second device substrate includes a plurality of the discharge outlets for discharging a plurality of types of liquids, at least one of the types of liquids being used for at least one output image and not being used for at least one other output image; and
a number of types of liquids only used for a particular output image in at least the first device substrate and the second device substrate is arranged to be the same.

19. An imaging apparatus that forms an image by discharging liquid from a recording head, the apparatus comprising:
a liquid cartridge including
a liquid container that stores liquid; and
a liquid discharge head that is in communication with the liquid container and receives the liquid from the liquid container, the liquid discharge head including
a discharge outlet for discharging liquid;
a flow path that is in communication with the discharge outlet and is configured to supply the liquid to the discharge outlet;
a flow path partitioning wall that is arranged between an adjacent pair of the flow paths; and
a plurality of device substrates including at least a first device substrate and a second device substrate, the device substrates including energy generating means for applying energy to the liquid in the liquid flow path and inducing the liquid to be discharged from the discharge outlet; wherein
each of at least the first device substrate and the second device substrate includes a plurality of the discharge outlets for discharging at least five types of liquids, at least one of the types of liquids being used for at least one output image and not being used for at least one other output image; and
for each output image, a difference in a number of types of liquids used in at least the first device substrate and the second device substrate is arranged to be no more than one.

20. An imaging apparatus that forms an image by discharging liquid from a recording head, the apparatus comprising:
a liquid cartridge including
a liquid container that stores liquid; and
a liquid discharge head that is in communication with the liquid container and receives the liquid from the liquid container, the liquid discharge head including
a discharge outlet for discharging liquid;
a flow path that is in communication with the discharge outlet and is configured to supply the liquid to the discharge outlet;
a flow path partitioning wall that is arranged between an adjacent pair of the flow paths; and
a plurality of device substrates including at least a first device substrate and a second device substrate, the device substrates including energy generating means for applying energy to the liquid in the liquid flow path and inducing the liquid to be discharged from the discharge outlet; wherein
each of at least the first device substrate and the second device substrate includes a plurality of the discharge outlets for discharging at least five types of liquids, at least one of the types of liquids being used for at least one output image and not being used for at least one other output image; and
a difference in a number of types of liquids only used for a particular output image in at least the first device substrate and the second device substrate is arranged to be no more than one.
